(19) United States
(12) Patent Application Publication
(10) Pub. No.: US 2024/0153478 A1
(43) Pub. Date: May 9, 2024

(54) SYSTEMS AND METHODS FOR MUSICAL PERFORMANCE SCORING

(71) Applicant: Spotify AB, Stockholm (SE)

(72) Inventors: Rachel Malia BITTNER, Paris (FR); Daniel STOLLER, Bonn (DE); Juanjo BOSCH, Barcelona (ES)

(21) Appl. No.: 18/054,119

(22) Filed: Nov. 9, 2022

(51) Int. Cl. G10H 1/36

(52) U.S. Cl. CPC G10H 1/361; G10H 2210/091

(57) ABSTRACT

An electronic device pre-processes a target audio track, including determining, for each time interval of a plurality of time intervals of the target audio track, a multi-pitch salience. The electronic device presents the target audio track at a device associated with the user. While presenting the target audio track at the device associated with the user, the electronic device receives an audio data stream representative of a user's musical performance and scores the user's musical performance with respect to the target audio track by comparing, respectively, for each time interval of the plurality of time intervals of the target audio track, (i) a pitch of the user's musical performance represented by the audio data stream to (ii) the multi-pitch salience.

### TECHNICAL FIELD

The disclosed embodiments relate generally to media provider systems, and, in particular, to scoring a user's singing with respect to a target audio track provided by a media provider.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task.

In an effort to provide additional user experiences to users that consume media content, media content providers also provide sing-along or other interactive experiences. Access to such a large library of content allows a user to consume, or sing along to, any number of audio tracks. A media content provider processes the library of content to allow a user to interact with any of the content.

### SUMMARY

A media content provider may present content for a user to sing along to a content item, and optionally provides feedback of how well the user is matching the content item, such as by providing a score to the user. In some embodiments, the score represents how well a singer is matching a vocal pitch of the target content item. While it is known to score a user's singing with respect to a target audio track, conventional systems use manual labeling of the target audio track to produce the target pitches, which is not scalable for large catalogs of target audio tracks. In addition, conventional systems only consider one correct pitch at a time, which is inappropriate in some circumstances, e.g., for tracks with harmonized singing or that otherwise include multiple voices.

In the disclosed embodiments, systems and methods are provided for scoring how well a singer is matching a vocal pitch (e.g., while singing karaoke) of a target audio track. The disclosed embodiments pre-process a library of tracks to generate, for a series of time windows of the tracks (e.g., 10 ms time windows), a distribution of pitches (the “multi-pitch salience”). The user's singing is then scored based on how well the singing matches the multi-pitch salience (e.g., the fundamental frequency of the user's singing is compared to a plurality of values of the multi-pitch salience, rather than a single value for a point in the track).

To that end, in accordance with some embodiments, a method is provided. The method includes pre-processing the target audio track, including determining, for each time interval of a plurality of time intervals of the target audio track, a multi-pitch salience. The method includes presenting the target audio track at a device associated with the user. The method further includes, while presenting the target audio track at the device associated with the user, receiving an audio data stream of the user's singing. The method includes scoring the user's singing with respect to the target audio track by comparing, for each time interval of the plurality of time intervals of the target audio track, a pitch of the user's singing to the multi-pitch salience.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprise instructions for performing any of the methods described herein.

Thus, systems are provided with improved methods for scoring a user's singing with respect to a target audio track.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIGS. 4A-4C are block diagrams illustrating a method for scoring a user's singing with respect to a target audio track, in accordance with some embodiments.

FIGS. 5A-5C are flow diagrams illustrating a method of scoring a user's singing with respect to a target audio track, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

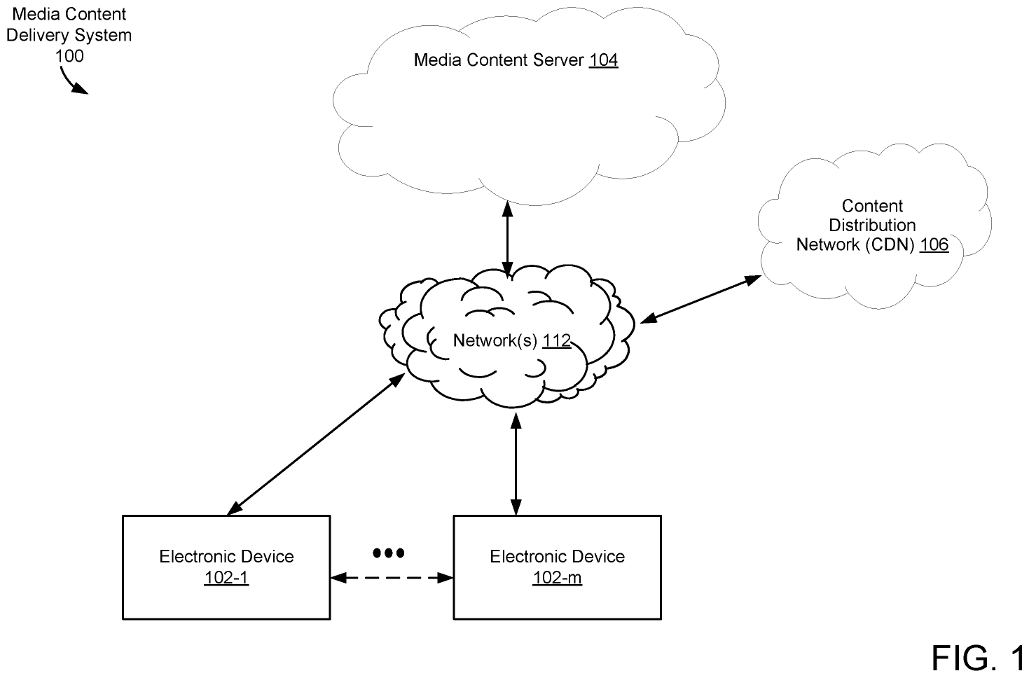

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 (also referred to herein as a user device) is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

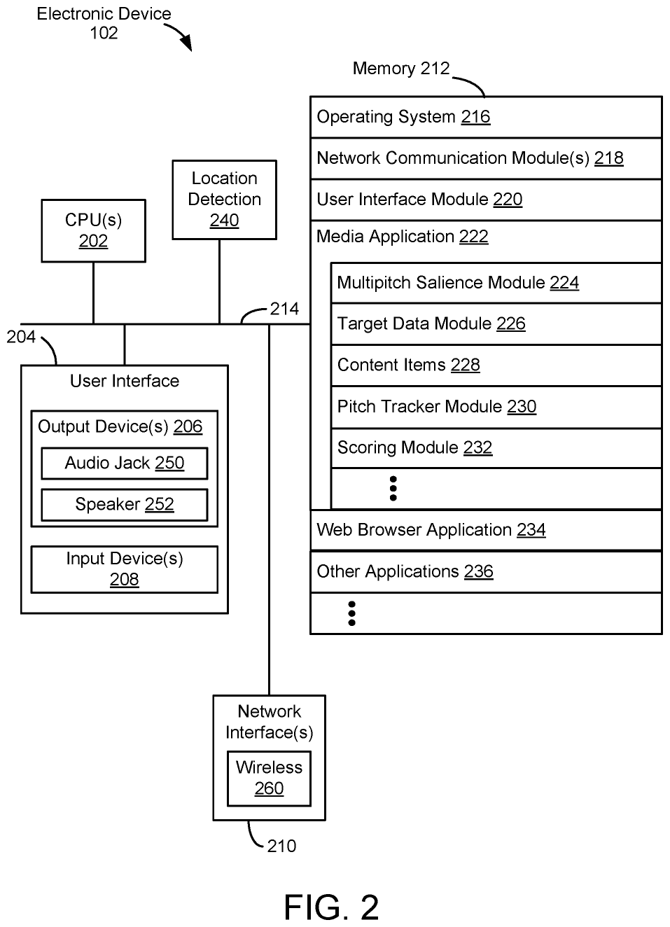

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or trackpad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the client device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a multi-pitch salience module 224 for calculating and/or storing a multi-pitch salience of a respective media item;
   a target data module 226 for compressing and/or storing target data, including calculated target vocal pitch likelihoods and/or a target volume curve for a respective media item;
   a content items module 228 for storing media items, including audio items such as podcasts and songs, for playback and/or for forwarding requests for media content items to the media content server;
   a pitch tracker module 230 for determining, in real-time, a pitch of a user's singing detected by input device(s) 208 (e.g., a microphone). In some embodiments, the pitch tracker module comprises a monophonic pitch tracker or a polyphonic pitch tracker;
   a scoring module 232 for scoring the user's singing and/or displaying the score, including calculating a cumulative score in real-time and/or a global score for an entire media item;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

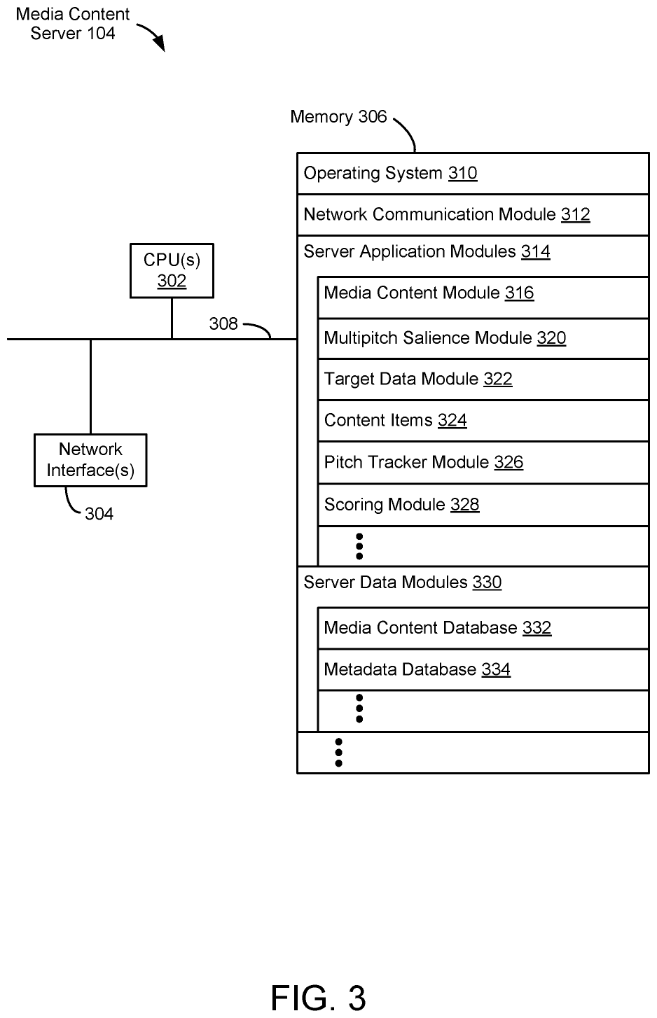

FIG. 3 is a block diagram illustrating a media content server 104 (another electronic device), in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a multi-pitch salience module 320 for calculating and/or storing a multi-pitch salience of a respective media item;
   a target data module 322 for compressing and/or storing target data, including calculated target vocal pitch likelihoods and/or a target volume curve for a respective media item;
   a content items module 324 for storing media items, including audio items such as podcasts and songs, for playback and/or for forwarding requests for media content items to the media content server;
   a pitch tracker module 326 for determining, in real-time, a pitch of a user's singing detected by electronic device 102). In some embodiments, the pitch tracker module comprises a monophonic pitch tracker or a polyphonic pitch tracker;
   a scoring module 328 for scoring the user's singing and/or displaying the score, including calculating a cumulative score in real-time and/or a global score for an entire media item;
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

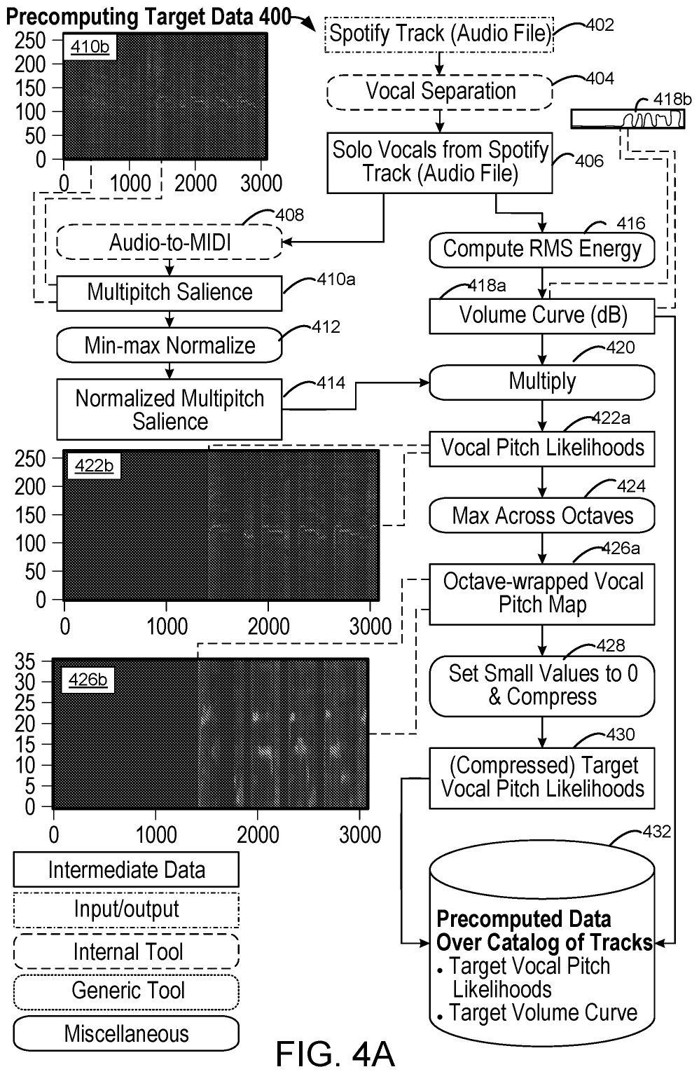

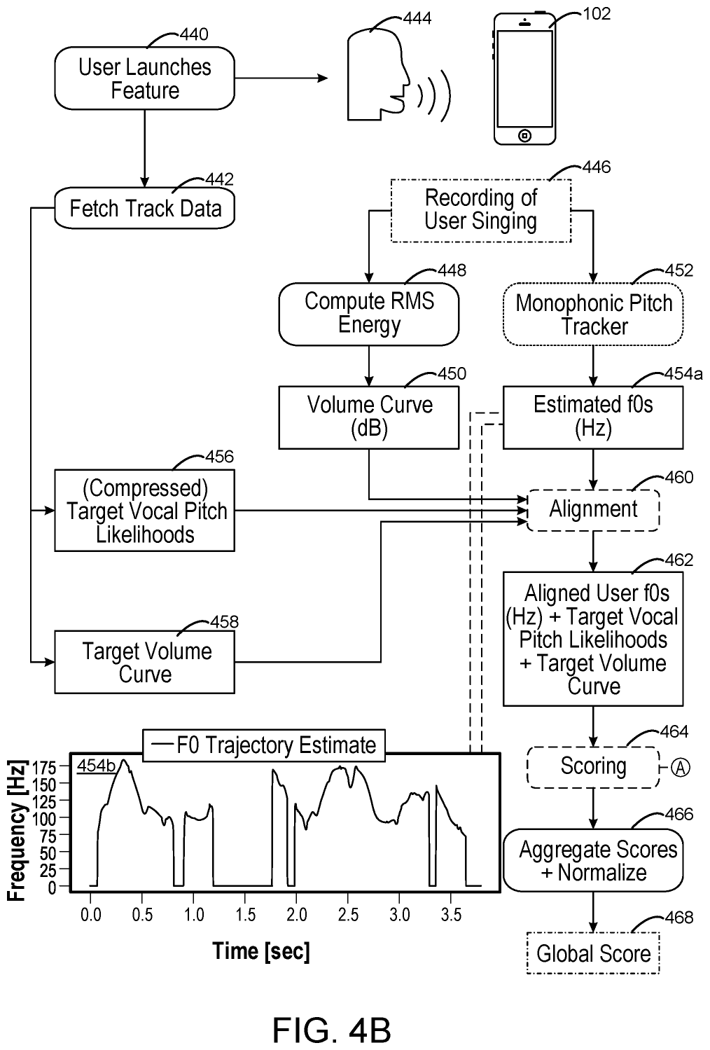

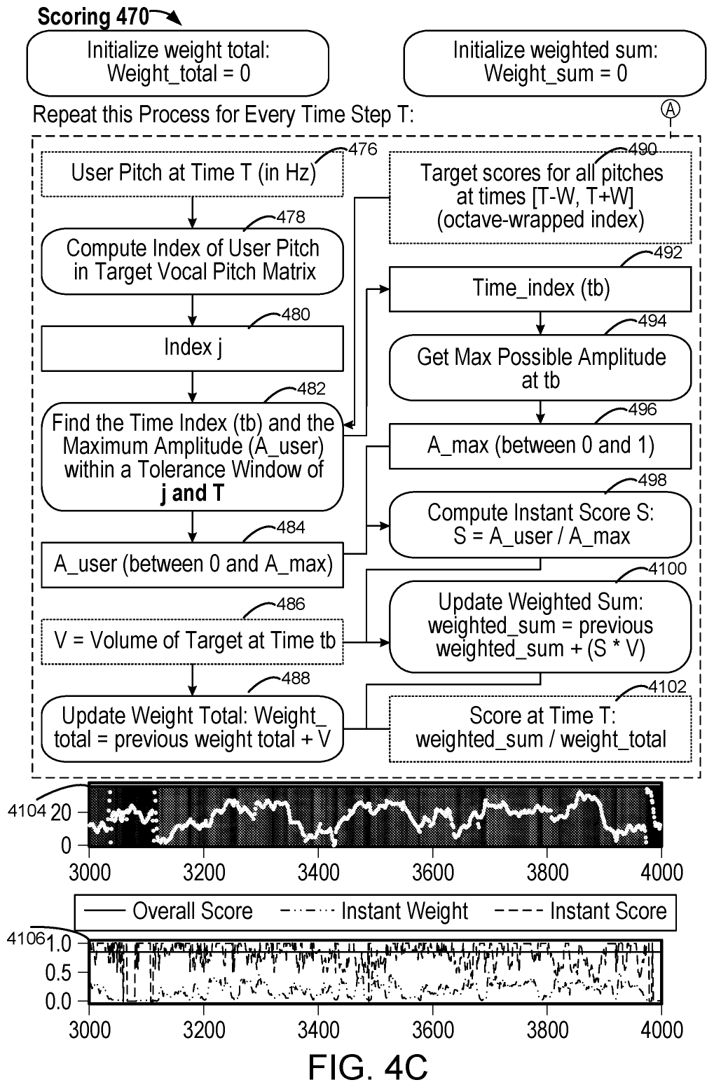

FIGS. 4A-4C are block diagrams illustrating a process for scoring a user's singing in accordance with some embodiments. In particular, FIG. 4A illustrates a process 400 for precomputing target data, including computing target vocal pitch likelihoods and/or a target volume curve for a target audio track. In some embodiments, the computed target data is stored (optionally in a compressed format), for example in association with a media item (e.g., the target audio track), such that in response to a user request for the media item, the precomputed target data is available to enable scoring of the user-provided vocals (e.g., the user's singing) relative to the precomputed target data for the media item. In some embodiments, the process 400 is performed on a plurality of audio tracks (e.g., a collection of audio tracks selected from a media library), and the precomputed data for the plurality of tracks is stored. In this way, an electronic device is enabled to access the precomputed data in response to a user request for a particular audio track from the plurality of audio tracks.

To that end, an audio file 402 (e.g., the target audio track) is provided. The system, such as a server system (e.g., media content server 104) and/or an electronic device 102, performs vocal separation 404 on the audio file 402. In some embodiments, the vocal separation is performed using a neural network that is trained to separate a vocal portion of the audio file from non-vocal (e.g., instrumental) portions of the audio file (e.g., because a singer should not be scored against an instrumental portion of the track). In some embodiments, the vocal portion of the audio file 406 is then input to an audio-to-MIDI converter 408, which encodes the vocal portion of the audio file 406 into a MIDI file (e.g., as described in more detail in U.S. patent application Ser. No. 17/515,179, which is incorporated herein by reference in its entirety), wherein the system determines a multi-pitch salience 410a using the MIDI file. In some embodiments, the multi-pitch salience 410a is represented as a Mel-frequency spectrogram 410b.

The multi-pitch salience 140a is an estimate of the likelihood that each pitch is being sung at a given moment (e.g., where a moment should be understood in the context of singing to represent a short window in time, such as 10-250 milliseconds. In some embodiments, multi-pitch salience 140a is represented as a matrix, where each column corresponds to a point or window in time (e.g., every 10-250 milliseconds), and each row corresponds to a particular pitch. The value at each element of the matrix represents a likelihood that a corresponding pitch is active (i.e., sung in the target track) at a corresponding point in time. Accordingly, in the matrix, more than one pitch can be likely at the corresponding time.

In some embodiments, the system normalizes 412 the multi-pitch salience, optionally using a min-max normalization process. In some embodiments, the multi-pitch salience matrix is reduced to a vocal pitch curve, for example by selecting the maximum likelihood at each point in time.

In some embodiments, the system computes root-mean-square (RMS) energy 416 of the vocal portion of the audio file 406 to generate a volume curve 418a (a representation of the volume curve 418b is illustrated in FIG. 4A), optionally in parallel to computing the multi-pitch salience 410a. In some embodiments, the system stores the volume curve 418a for the audio file (e.g., as precomputed data 432). For example, the volume curve 418a estimates a volume level, in decibels (dB), of the vocal portion of the audio file 406 at each point in time.

In some embodiments, the system multiplies 420 the normalized multi-pitch salience 414 with the volume curve 418a. As such, the system determines vocal pitch likelihoods 422a, shown in representation 422b. By multiplying the normalized multi-pitch salience 414 with the volume curve 418a (e.g., volume curve 418a is a curve of volume as a function of time), the system removes portions of the multi-pitch salience that likely do not correspond to vocals. For example, low volume levels (e.g., with values close to 0) at respective times multiplied by the multi-pitch salience of that time, cancel out (e.g., remove) the multi-pitch salience values at times of low vocal volume (e.g., in which noise tends to dominate the multi-pitch salience, and thus it would be unfair to score the singer's scoring in the same manner as a period of high vocal volume). For example, the representation 422b of the vocal pitch likelihoods illustrates that portions of the multi-pitch salience are zeroed out (e.g., illustrated by the solid black in the first half of representation 422b because the volume curve 418b is close to zero for that time period).

In some embodiments, the system performs octave wrapping by maximizing the vocal pitch likelihoods across different octaves 424 (as it would be unfair to require a soprano to sing in the same octave as a target track's bass singer). The octave-wrapped vocal pitch map 426a is illustrated as representation 426b. Representation 426b illustrates the vocal pitch likelihoods repeating across different octaves. For example, within a same band, additional pitches are highlighted in representation 426b (as opposed to the vocal pitch likelihood representation 422b, before octave-wrapping). This approach also mitigates the problem of octave mistakes, which are common in pitch tracking algorithms, and in which choosing a single pitch over time will often result in jitter between equivalent pitches at different octaves. In some embodiments, the target pitch likelihoods that are computed are wrapped to a “single-octave” representation. As such, if a user with a high-pitch voice sings a song where the original singer has a low-pitched voice, the user will likely sing in a different musical octave than the original, but this should be considered correct (e.g., and be awarded a correspondingly high score). By octave-wrapping the target information, it does not matter what octave the user sings in vis-à-vis the target track vocals, only whether the user's singing matches in octave-equivalent pitch (e.g., C4 on the piano versus C5 on the piano).

In some embodiments, the system sets values of vocal pitches that do not satisfy a threshold value (e.g., small values) to zero 428 and compresses the vocal pitch likelihoods 430, which are stored in the system as precomputed data 432. For example, the system performs post-processing of the multi-pitch salience to have low energy when the vocals have low volume. In some embodiments, the vocal pitch likelihoods correspond to a distribution over possible pitches (e.g., for each point in time, it gives the likelihood that each possible pitch is correct).

In some embodiments, the stored precomputed data 432 is accessed for a particular track in response to a user requesting the track, as described with reference to FIG. 4B.

FIG. 4B illustrates a system overview that aligns precomputed data 432 for the audio file 402 with a user's singing (e.g., optionally in real-time), to score the user's singing. For example, the process is initiated with the user launching the interactive feature 440 (e.g., using an application of the media-providing service). In some embodiments, the interactive feature 440 is a sing-along and/or karaoke feature (wherein the karaoke feature optionally displays lyrics and/or removes a vocal track of a selected media item). In some embodiments, the interactive feature 440 is a singing scorer feature.

In some embodiments, in response to the user launching feature 440, the system fetches data 442 (e.g., audio data and/or precomputed data 432) for the selected media item (e.g., audio track). In some embodiments, the system streams, or otherwise provides for playback, at least a portion of the audio track (e.g., the instrumental portion, optionally without a vocal portion of the audio track or the audio track including both instrumental and vocal portions). In some embodiments, the track data also includes the (optionally compressed) target vocal pitch likelihoods 456 and target volume curve 458.

In some embodiments, electronic device 102 detects a user's singing 444, or other audio input via a microphone or input device of electronic device 102. In some embodiments, electronic device 102 is communicatively coupled to a server system that stores the track data 442. In some embodiments, the electronic device 102 locally stores the track data 442. In some embodiments, electronic device 102 provides (e.g., streams or plays back) audio data (e.g., instrumental and/or vocal portions) of the track associated with track data 442 (e.g., the media content item is played at electronic device 102, or another presentation device communicatively coupled to electronic device 102).

In some embodiments, electronic device 102 records 446 the user's singing, and optionally forwards the recording to a server system for scoring (or performs the process for scoring, described below, locally at the electronic device 102). In some embodiments, the system computes RMS energy 448 of the user's singing, and generates a volume curve 450.

In some embodiments, the system uses a monophonic pitch tracker 452 to estimate a fundamental frequency (f₀) 454a respectively for each time period of the user's singing, as displayed in the graph 454b, which represents the estimated fundamental frequency of the user's singing at different time periods of the recording. As such, the fundamental frequency represents an estimate of the pitch the user is singing in real time (e.g., computed using a real-time compatible monophonic pitch tracker). In some embodiments, the monophonic pitch tracker outputs a single pitch for each frame (e.g., time stamp), and, in some instances, returns “no pitch” (e.g., a frequency of 0) at certain time periods.

In some embodiments, the system uses the estimated frequency 454a, the volume curve 450, and the target track data (456 and 458) to perform alignment 460 on the user's singing relative to the media item. For example, alignment 460 is performed because, in some embodiments, the target pitch data and the user's pitch data are not well aligned with each other (e.g., due to latency in hardware devices or network connections, or software-related issues). In some embodiments, alignment 460 is performed by using cross-correlation between the time series of energy and pitch for both user and target data. For example, cross-correlation gives the correlation for multiple lags, such that one can determine the lag that maximizes the correlation between the target data and the user data (e.g., the user's singing). The output of the cross-correlation is a vector, wherein each component corresponds to the correlation with a specific lag. In some embodiments, cross-correlation is computed for both energy and pitch correlations. In some embodiments, cross-correlation is computed for a section, less than all, of the user's singing data (e.g., for a rolling time window), such as for 10 seconds of data in order to be able to do online scoring.

In some embodiments, cross-correlation is first computed using energy. For example, the energy correlation (C e) is computed between the two energy time series for multiple lags. This cross-correlation represents when the user sings at the same moments as the original singer, independently of the user's score (e.g., whether the user's singing is on pitch). In some embodiments, a proxy of the energy is used, such as the weight or “volume” of each frame (e.g., window of time, also referred to as a time step), for target and user.

In some embodiments, cross-correlation C p is computed using pitch information (optionally after computing the cross-correlation using energy). In some embodiments, the target pitch likelihoods form a matrix, and user pitches are represented by a vector of scalars (wherein each scalar element of the vector represents a time). The user pitches are first transformed into a matrix “P u” with a similar format as the target pitch likelihoods matrix. This is done by computing the bin corresponding to the user pitch for every frame (e.g., where a frame represents a period time), and then setting the value of that Pᵤ[bin,frame]=1.

In some embodiments, a pitch estimator that gives a value of confidence for every frame is used, wherein:

Pᵤ[bin,frame]=conf[frame],
where the pitch correlation (Cₚ) is computed between the target pitch likelihoods and the matrix of pitches sung by the user (Pᵤ), for multiple lags. For example, this type of cross-correlation is beneficial when the user sings with the same pitches as the original singer.

Each of the cross-correlation vectors are normalized:

Cₑ=Cₑ/max(Cₑ)

Cₚ=Cₚ/max(Cₚ)

And finally a combined cross-correlation is computed by summing both vectors (C=Cₑ+Cₚ). In some circumstances, combining the vectors gives better behavior for users that do not sing perfectly in pitch but sing in the right places, or the other way round, for singers that sing well in pitch, but are singing in only parts of the song, or even singing in sections of the song where the original singer was not singing.

Finally, the lag which maximizes the combined cross correlation is determined using: lag=argmax(C), which can be transformed into time, by multiplying by the hop size (in seconds):

Time_{lag}=lag×hop_size

To obtain the aligned user data, the pitch data is shifted in time by the Time_{lag}.

In some embodiments, after alignment of the user's singing relative to the target data 462, using both energy (e.g., target volume curve) and pitch information (target vocal pitch likelihoods) as explained above, the system performs scoring 464, as described in more detail with reference to FIG. 4C.

In some embodiments, the system aggregates the scores 466 (described below) and normalizes the aggregated score to generate a global score 468 that represents the user's singing over the entire media item.

FIG. 4C illustrates a process for scoring 470 the user's singing for a respective time step, T, (also referred to as a frame) to generate a frame score (e.g., a quasi-instantaneous score). In some embodiments, the frame score for the current time period is used to calculate a cumulative score that also takes into account the previously computed frame scores in the preceding time periods (e.g., the cumulative score is an ongoing score that represents the user's singing up until, and including, the current time period). In some embodiments, the process described with reference to FIG. 4C is repeated for each time step in the media item (as the media item plays back and the user's singing is recorded). For example, the user's pitch (in Hertz (Hz)) is recorded at a time step, T (476), and the system computes (e.g., looks up) an index (j) of a corresponding pitch in the target vocal pitch matrix 478 (also referred to herein as the target vocal pitch likelihoods and/or multi-pitch salience).

The system also identifies the target scores 490 for all of the pitches (e.g., which have previously been octave-wrapped at 426a) that are stored in the precomputed target vocal pitch matrix at times T-W and T+W (e.g., between the current time step, T, adjusted by tolerance window W). In some embodiments, the tolerance window W is adjusted based on a difficulty threshold. For example, a smaller tolerance window is selected for a more difficult level and a larger tolerance window is selected for an easier level. For example, a small tolerance means the user has to match the pitch exactly, whereas a larger tolerance allows the user to be further from the target pitch. In some embodiments, a user is enabled to select the difficulty level (e.g., easy, medium, or difficult) for the singalong feature (and the system adjusts the tolerance window in accordance with the selected difficulty level). In some embodiments, the difficulty levels are more granular (e.g., the user can adjust the level to be “easier” or “harder”) than easy, medium, or difficult, because the tolerance windows can be more finely adjusted than in conventional systems.

For the computed index j (480), the system, using the target scores 490, finds a time index (t_{b}) and maximum likelihood (amplitude, Aᵤₛₑᵣ 484), of the user within a tolerance window of j and T (482). In addition, the system determines, for a respective time index (t_{b}) 492, the maximum possible amplitude 496 for the respective time index (t_{b}) 494 (e.g., normalized between 0 and 1). For example, for a given frame corresponding to index j, the user's pitch is computed, Aᵤₛₑᵣ 484 for the user's pitch is computed, the pitch with the greatest amplitude in the target pitch data, and the maximum possible amplitude 496 for that pitch is computed. The frame score, S (498), for a time step T is computed as the ratio between the target likelihood of the user's pitch (A user 484), and the highest possible likelihood for that frame (Aₘₐₓ 496). As such, the scoring method 470 does not penalize the user for singing any valid pitch, rather than “the” valid pitch. For example, if the user sings within a tolerance window of the most likely pitch, the instant score is 1, and if they sing another likely pitch, they will get a score below, but close to 1. If they sing an extremely unlikely pitch, the score will be close to 0.

In a simplified example, the multi-pitch salience for a respective frame of a track is given by:

TABLE 1

| | multi-pitch salience of a |
|---|---|
| Pitch Bin | frame of a target track |
| 1 | 0 |
| 2 | 0 |
| 3 | 0 |
| 4 | 0 |
| 5 | 0 |
| 6 | 0.4 |
| 7 | 0 |
| 8 | 0 |
| 9 | 0 |
| 10 | 0.6 |
| 11 | 0 |
| 12 | 0 |

Further, in this example, the user sings a pitch corresponding to pitch bin #6. A frame score is calculated by first determining the target likelihood (multi-pitch salience) around the user's pitch. Although various embodiments are described herein for providing tolerance windows in both pitch and time, in this simplified example, the target likelihood (multi-pitch salience) around the user's pitch is the value of 0.4 corresponding to pitch #6. The frame score is further calculated by computing a ratio between the target likelihood around the user's pitch, and the highest possible target likelihood for that frame, which, in this example is 0.6, corresponding to pitch #10. Thus, the frame score in this simplified example is 0.4/0.6=0.66.

The computed frame score, S, 498 of the user, is then weighted based on the volume of target data 486 (e.g., retrieved from the precomputed data 432) at the time index t_{b}. For example, the weights are the target vocal volume at each frame. As such, the “vocal volume” is used as a weighting factor in the overall score. Parts of the song that are unlikely to have vocals in them do not count greatly toward the overall score, whereas parts that are very likely to have vocals have a high impact on the global (overall) score. This removes the need to make a binary decision on whether or not there is singing voice at each point in time. In some embodiments, at time indices for which no vocals are present, there is no likely pitch identified, and the frame score has no meaning (e.g., is dominated by noise). In some embodiments, because the frame score can be noisy, the system presents the user with the cumulative score and/or global score without presenting the frame score.

In some embodiments, the system calculates the cumulative score by updating the previous weighted sum 4100 and weight total 488. For example, the frame score is combined with the previously-calculated frame scores (calculated for prior time steps (frames) in the same media item). The system determines a real-time score, representing the cumulative score 4102 of the user's singing as calculated up to time T. In some embodiments, the global score (468) is the aggregated cumulative score (e.g., after normalization, described below), and the system presents the global score to the user to represent how well the user's singing matched the target multi-pitch salience over the entire media item.

The graph 4104 illustrates a detected (e.g., recorded) user's singing over a time period. The graph 4106 illustrates scores that are calculated from the user's singing, including an overall score (e.g., the global score) and the frame score, which is calculated using the weight at the given frame, the weight corresponding to the target vocal volume at the frame.

In some circumstances, if not otherwise addressed, a random singer and/or noise could obtain high scores if the pitch and time tolerances are high. For example, for a pitch tolerance of 12 semitones, a random singer would score 100%. Similarly, a relatively high pitch tolerance, such as of 5 bins, and time tolerance of ±3 frames, could result in a 60% score for a random singer and/or noise (e.g., depending on the target pitches).

In some embodiments, to give a score that correlates better with the singer's performance (e.g., in terms of similarity of pitch to the original singer), the score is normalized 466 (FIG. 4B) with respect to the score that noise (or a random singer) would get for the target track, with the specific time and pitch tolerance. The normalization process is performed on an individual target track basis because the target data varies widely between tracks, and thus, random singing could get higher scores in some tracks in comparison to others (e.g., in a song where there are harmonies, many pitches are “correct”, and therefore a random singer would get a higher score).

Accordingly, to normalize the score, the score is estimated for random singing, rs_score. In some embodiments, the random singing score is estimated by running noise through the scoring algorithm, and getting the score. In some embodiments, this is performed repeatedly with different types of noise to obtain an average rs_score.

In some embodiments, the maximum score is achieved whenever the user's score is higher than a threshold value (e.g., MAX_SCORE=0.95).

The user's final (normalized) score, also referred to herein as global or overall score 468, is defined as:

final_score=(score−rs_score)/(MAX_SCORE−rs_score),

which is then adjusted to be between 0 and 1:

final_score=min(1,max(0,final_score)).

In some embodiments, the scoring system described herein is fully automatic (e.g., without manual labelling of the target pitches) and robust to errors in estimated target pitch likelihoods (unlike an estimated pitch tracker algorithm). For example, the system described herein allows for more than one correct answer (e.g., if two singers are present at the same time and the user chooses one or the other, they will both usually have a high likelihood in the target pitch, and the user would not be penalized).

In some embodiments, the system is not constrained to “piano pitches,” and instead may divide the octave along a finer frequency resolution (36 bins, rather than 12). For example, in some tracks, the singing voice is fluid, and singers rarely sing exactly along the standard, in-tune piano note grid. Singers may deviate from this grid with vibrato, slides, etc. In addition, in non-western music, singers may target notes which do not fall exactly along the western piano grid. This more finely divided grid lets the target pitch information capture artistic deviations in pitch, as well as not failing when different musical scales are used.

In some embodiments, the monophonic pitch tracker used to estimate the user's singing outputs a pitch distribution (e.g., like the matrix described with reference to target pitch data), instead of one pitch, per time period. In some embodiments, the scoring method described above is used to compute the score by comparing the target pitch distribution against the user pitch distribution. For example, the electronic device calculates the frame score between 0 and 1 for each of the user pitches that are considered to be likely (e.g., have a likelihood that satisfies a threshold) according to the pitch tracker distribution (e.g., instead of just for one pitch). In some embodiments, the overall score is calculated as the best (e.g., highest) out of all these possible scores (e.g., so that the user is not punished even if the monophonic pitch tracker is inaccurate but still assigns a moderate likelihood to the pitch that the user actually sang). In some embodiments, the scores obtained for each pitch (in the pitch distribution) are summed, with each score weighted by the likelihood of each user pitch.

In some embodiments, statistical divergences are calculated between the pitch distribution of the user's singing and the target pitch data, in order to measure the distance between the two probability distributions.

Although the method described above uses the example of pitch accuracy, in some embodiments, the method is also used to measure accuracy of other musical attributes (e.g., pitch of another instrument, lyrics, volume, playing technique) by replacing the target likelihood maps and the attribute estimated for the user. In some embodiments, rather than the user's singing, the method described above is applied mutatis mutandis to the user's performance in playing a pitched instrument (e.g., a violin, trombone, etc.). In such embodiments, the method described above is likely to produce better results as compared to conventional methods when the user is performing a single part in, e.g., a musical piece with multiple parts. For example, the methods described herein are applied to score the pitch of monophonic or polyphonic instruments (e.g., corresponding to a user's musical performance). Instead of running vocal separation 404, a source separation model to separate the target instrument is used (e.g., an instrument-specific, or conditioned source separation model). When computing the target pitch distribution, the valid pitch range in the multi-pitch salience matrix could be reduced to adjust for the target instrument's range (e.g., bass could remove high frequencies), or, in the case of polyphonic instruments, the user pitch is a distribution from a polyphonic tracker.

In some embodiments, the method above is applied to scoring non-pitch characteristics (e.g., lyrics, volume, playing technique). Note that the manner in which the target likelihoods are handled may differ when the method described above is applied to characteristics other than pitch. In some embodiments, different characteristics are given different tolerances and/or the manner in which “correctness” is measured may differ between different characteristics. For example, when scoring a singing pitch of the user, in some embodiments, the user's pitch is allowed to be “off” by some number of bins (e.g., a bin tolerance) and still be considered correct. For other attributes, the user's characteristic is considered correct only if it matches a single respective correct attribute (e.g., for lyrics, if the user is singing the phoneme \e\, the score is based on the likelihood that the target singer is singing \e\, ignoring any phoneme relationships). In some embodiments, the scoring of the other attributes is flexible (e.g., similar to allowing the user's pitch to be “off” but still correct) by, for example, manually defining a graph of relationships (e.g., \e\ is one step away from \a\), wherein if the user is singing a phoneme that is incorrect, but close in the graph to the target phoneme (e.g., within a threshold number of steps, or within a threshold distance as defined by edges of the graph), the user is still given a high score.

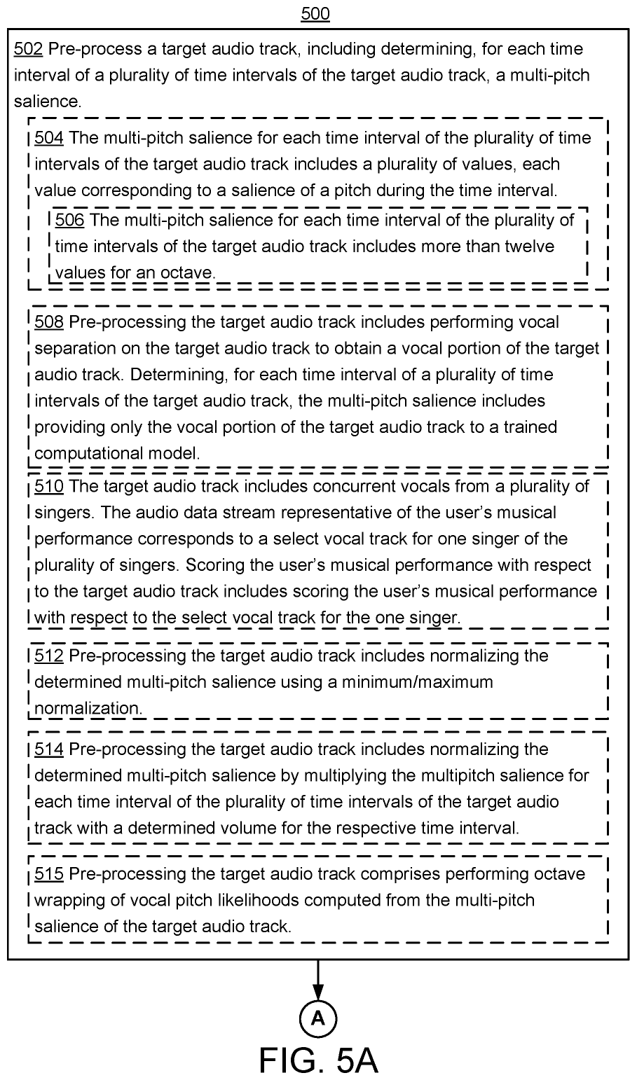

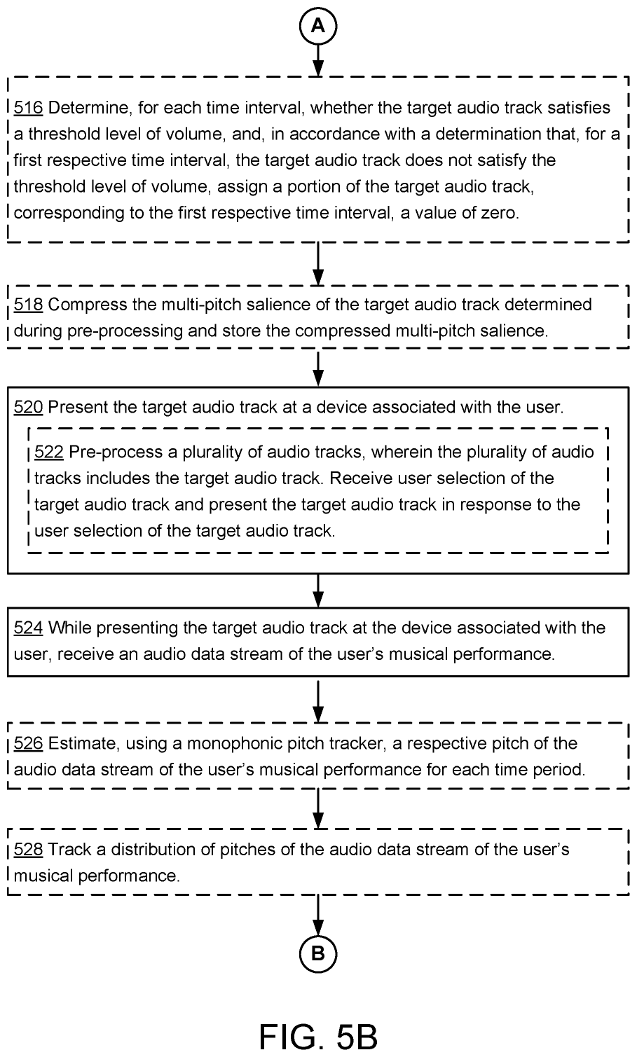

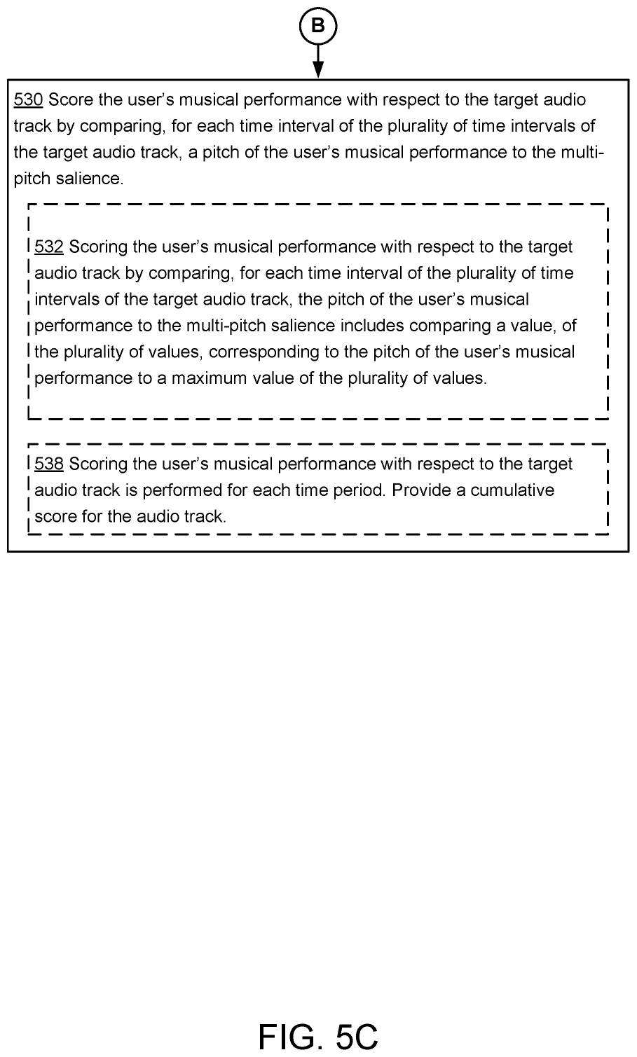

FIGS. 5A-5C are flow diagrams illustrating a method 500 of scoring a user's singing with respect to a target audio track, in accordance with some embodiments. Method 500 may be performed at an electronic device (e.g., media content server 104 and/or electronic device(s) 102, such as a user device) having one or more processors and memory storing instructions for execution by the one or more processors. In some embodiments, the method 500 is performed by executing instructions stored in the memory (e.g., memory 212, FIG. 2, memory 306, FIG. 3) of the electronic device. In some embodiments, the method 500 is performed by a combination of the server system (e.g., including media content server 104 and CDN 106) and a client device.

Referring now to FIG. 5A, in performing the method 500, the electronic device pre-processes (502) a target audio track, including determining, for each time interval of a plurality of time intervals of the target audio track, a multi-pitch salience (e.g., using a trained computational model, as described with reference to step 410a (FIG. 4A)).

In some embodiments, the multi-pitch salience for each time interval of the plurality of time intervals of the target audio track includes (504) a plurality of values, each value corresponding to a salience of a pitch during the time interval.

In some embodiments, the multi-pitch salience for each time interval of the plurality of time intervals of the target audio track includes (506) more than twelve values for an octave. For example, as described above, the system divides the octave along a finer frequency resolution (36 bins, rather than 12) while determining the multi-pitch salience.

In some embodiments, pre-processing the target audio track includes (508) performing vocal separation on the target audio track to obtain a vocal portion of the target audio track and determining, for each time interval of a plurality of time intervals of the target audio track, the multi-pitch salience includes providing only the vocal portion (or other separated portion, e.g., of another instrument) of the target audio track to a trained computational model. For example, vocal separation 404 is performed on the audio track such that multi-pitch salience 410a is only calculated for the vocal portion of an audio file 402.

In some embodiments, the target audio track includes (510) concurrent vocals from a plurality of singers. In some embodiments, the audio data stream representative of the user's musical performance corresponds to a select vocal track for one singer of the plurality of singers; and scoring the user's musical performance with respect to the target audio track includes scoring the user's musical performance with respect to the select vocal track for the one singer (e.g., without penalizing the user for only singing (e.g., performing) one of the vocal tracks).

For example, the audio file 402 includes harmonies and/or a duet portion in which more than one singer is contributing to the vocal portion of the track at a given time.

In some embodiments, pre-processing the target audio track includes (512) normalizing the determined multi-pitch salience using a minimum/maximum normalization, as described at step 412 (FIG. 4A).

In some embodiments, pre-processing the target audio track includes (514) normalizing the determined multi-pitch salience by multiplying the multi-pitch salience for each time interval of the plurality of time intervals of the target audio track with a determined volume (e.g., in volume curve 418a) for the respective time interval. For example, at step 420 the normalized multi-pitch salience 414 is multiplied with computed volume curve 418a. In some embodiments, the “vocal volume” is also used as a weighting factor in the overall score (as described with reference to 486 (FIG. 4C) the instant score, S, is weighted by the stored volume at the given time index).

In some embodiments, pre-processing the target audio track comprises (515) performing octave wrapping of vocal pitch likelihoods computed from the multi-pitch salience of the target audio track. In some embodiments, vocal pitch likelihoods 422a are computed by multiplying normalized multi-pitch salience 414 with volume curve 418a.

In some embodiments, the electronic device determines (516), for each time interval, whether the target audio track satisfies a threshold level of volume, and, in accordance with a determination that, for a first respective time interval, the target audio track does not satisfy the threshold level of volume, assigns the portion of the target audio track in the first respective time interval, a value of zero (e.g., even if the target audio track has a non-zero value) (e.g., step 428, set small values to 0).

In some embodiments, the electronic device compresses (518) the multi-pitch salience of the target audio track determined during pre-processing and stores the compressed multi-pitch salience, as described with reference to step 428 (FIG. 4A).

The electronic device presents (520) the target audio track at a device associated with the user. For example, in FIG. 4B, device 102 presents the target audio track while recording the user's singing 446.

In some embodiments, the electronic device pre-processes (522) a plurality of audio tracks, wherein pre-processing the plurality of audio tracks includes the pre-processing of the target audio track. For example, the electronic device pre-processes at least 50,000 audio tracks and stores the multi-pitch salience (and volume curve) determined for each audio track in the plurality. In some embodiments, the electronic device receives user selection of the target audio track and presents the target audio track in response to the user selection of the target audio track. As such, the electronic device need not process an audio track in real-time after receiving user selection of the audio track, and instead accesses the stored precomputed data 432 for the catalog of tracks.

While presenting the target audio track at the device associated with the user, the electronic device receives (524) an audio data stream of the user's musical performance (e.g., step 446, FIG. 4B). In some embodiments, the user's musical performance comprises the user's singing. In some embodiments, the device provides (e.g., displays) lyrics for the user to sing along with the displayed lyrics.

In some embodiments, the electronic device estimates (526), using a monophonic pitch tracker (e.g., or a polyphonic pitch tracker), a respective pitch of the audio data stream of the user's musical performance (e.g., singing, a monophonic or a polyphonic instrument) for each time period. For example, the electronic device estimates fundamental frequency f₀ (step 454a, FIG. 4B).

In some embodiments, the electronic device tracks (528) a distribution of pitches of the audio data stream of the user's musical performance. For example, as described above, in some embodiments, instead of the monophonic pitch tracker that computes the user's pitch outputting a single value, the pitch tracker outputs a distribution of pitches, and the scoring method described above is used to compute the score by comparing the target pitch distribution against the user pitch distribution.

The electronic device scores (530) the user's musical performance with respect to the target audio track by comparing, for each time interval of the plurality of time intervals of the target audio track, a pitch of the user's musical performance to the multi-pitch salience. For example, the scoring method 470 is described with reference to FIG. 4C.

In some embodiments, scoring the user's musical performance with respect to the target audio track by comparing, for each time interval of the plurality of time intervals of the target audio track, the pitch of the user's musical performance to the multi-pitch salience includes (532) comparing a value, of the plurality of values, corresponding to the pitch of the user's musical performance to a maximum value of the plurality of values. For example, for a given frame, the user's pitch is computed, and a lookup is performed of the index that pitch corresponds to in the target pitch data. The max likelihood (amplitude) of the target pitch distribution within a tolerance window of the index is selected. In some embodiments, the frame score for a frame is computed as the ratio between the target likelihood around the user's pitch, and the highest possible likelihood for that frame. For example, if the user sings within a tolerance window of the most likely pitch, the instant score is 1 (e.g., if the user sings another likely pitch, the user will get a score below, but close to 1 and if the user sings a very unlikely pitch, the score will be close to 0). In some embodiments, scoring the user's musical performance includes calculating an instantaneous score for a respective time interval of the plurality of time intervals by computing a ratio between the pitch of the user's musical performance, to a value within a tolerance window of the maximum value of the plurality of values for the time interval. For example, as explained above, the instantaneous score is calculated to allow for a tolerance around the target pitch likelihood, such that if the user's musical performance is within the tolerance window of the most likely pitch, the instantaneous score is 1. If the user's musical performance is close to another likely pitch, they will get a score below, but close to 1. If the user's musical performance corresponds to a totally unlikely pitch, the score will be close to 0.

In some embodiments, scoring the user's musical performance with respect to the target audio track is performed for each time period (e.g., the process described with reference to FIG. 4C is repeated for every time step, T), and the electronic device provides the user with a score that represents the score determined for the current time period (e.g., the frame score). In some embodiments, the frame score (e.g., the score of the user's for only the current time period, not including previously calculated scores for previous time periods) is not displayed to the user (e.g., because it can be noisy).

In some embodiments, scoring the user's musical performance with respect to the target audio track is performed (538) for each time period, and the electronic device provides (e.g., displays) a cumulative score for the audio track. In some embodiments, to calculate the cumulative score for the audio track, the weighted average of each score determined for each time period is calculated, wherein each score is weighted based on the vocal volume calculated for the corresponding time period. In some embodiments, a global score 468 is calculated and provided, wherein the global score comprises the normalized cumulative score at the end of the audio track.

Although FIGS. 5A-5C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for the purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method of scoring a user's musical performance with respect to a target audio track, comprising:
pre-processing the target audio track, including determining, respectively for each time interval of a plurality of time intervals of the target audio track, a multi-pitch salience;
presenting the target audio track at a device associated with the user;
while presenting the target audio track at the device associated with the user, receiving an audio data stream representative of the user's musical performance; and
scoring the user's musical performance with respect to the target audio track by comparing, respectively, for each time interval of the plurality of time intervals of the target audio track, (i) a pitch of the user's musical performance represented by the audio data stream to (ii) the multi-pitch salience.

2. The method of claim 1, wherein the multi-pitch salience for each time interval of the plurality of time intervals of the target audio track includes a plurality of values, each value corresponding to a salience of a pitch during the time interval.

3. The method of claim 2, wherein scoring the user's musical performance with respect to the target audio track by comparing, for each time interval of the plurality of time intervals of the target audio track, the pitch of the user's musical performance to the multi-pitch salience includes comparing a value, of the plurality of values, corresponding to the pitch of the user's musical performance to a maximum value of the plurality of values.

4. The method of claim 3, wherein scoring the user's musical performance includes calculating an instantaneous score for a respective time interval of the plurality of time intervals by computing a ratio between the pitch of the user's musical performance, to a value within a tolerance window of the maximum value of the plurality of values for the time interval.

5. The method of claim 2, wherein the multi-pitch salience for each time interval of the plurality of time intervals of the target audio track includes more than twelve values for an octave.

6. The method of claim 1, wherein:
pre-processing the target audio track includes performing vocal separation on the target audio track to obtain a vocal portion of the target audio track; and
determining, for each time interval of a plurality of time intervals of the target audio track, the multi-pitch salience model includes providing only the vocal portion of the target audio track to a trained computational model.

7. The method of claim 1, comprising:
pre-processing a plurality of audio tracks, wherein pre-processing the plurality of audio tracks includes the pre-processing of the target audio track;
receiving user selection of the target audio track;
presenting the target audio track in response to the user selection of the target audio track.

8. The method of claim 1, wherein:
the target audio track includes concurrent vocals from a plurality of singers;
the audio data stream representative of the user's musical performance corresponds to a select vocal track for one singer of the plurality of singers; and
scoring the user's musical performance with respect to the target audio track includes scoring the user's musical performance with respect to the select vocal track for the one singer.

9. The method of claim 1, further comprising, determining, for each time interval, whether the target audio track satisfies a threshold level of volume, and, in accordance with a determination that, for a first respective time interval, the target audio track does not satisfy the threshold level of volume, assigning a portion of the target audio track, corresponding to the first respective time interval, a value of zero.

10. The method of claim 1, further comprising, compressing the multi-pitch salience of the target audio track determined during pre-processing and storing the compressed multi-pitch salience.

11. The method of claim 1, wherein pre-processing the target audio track includes normalizing the determined multi-pitch salience using a minimum/maximum normalization.

12. The method of claim 1, wherein pre-processing the target audio track includes normalizing the determined multi-pitch salience by multiplying the multi-pitch salience for each time interval of the plurality of time intervals of the target audio track with a determined volume for the respective time interval.

13. The method of claim 1, wherein pre-processing the target audio track comprises performing octave wrapping of vocal pitch likelihoods computed from the multi-pitch salience of the target audio track.

14. The method of claim 1, wherein scoring the user's musical performance with respect to the target audio track is performed for each time period, and the method further comprises providing a cumulative score for the target audio track.

15. The method of claim 1, further comprising estimating, using a monophonic pitch tracker, a respective pitch of the audio data stream of the user's musical performance for each time period.

16. The method of claim 1, further comprising, tracking a distribution of pitches of the audio data stream of the user's musical performance.

17. The method of claim 1, wherein:
the pitch of the user's musical performance is a first pitch; and
scoring the user's musical performance with respect to the target audio track further includes comparing, respectively, for each time interval of the plurality of time intervals of the target audio track, (i) a second pitch of the user's musical performance, different from the first pitch, to (ii) the multi-pitch salience.

18. A first electronic device, comprising:
one or more processors; and
memory storing one or more programs, the one or more programs including instructions for:
pre-processing a target audio track, including determining, for each time interval of a plurality of time intervals of the target audio track, a multi-pitch salience;
presenting the target audio track at a second electronic device associated with a user;
while presenting the target audio track at the second electronic device associated with the user, receiving an audio data stream representative of a user's musical performance; and
scoring the user's musical performance with respect to the target audio track by comparing, respectively, for each time interval of the plurality of time intervals of the target audio track, (i) a pitch of the user's musical performance represented by the audio data stream to (ii) the multi-pitch salience.

19. The electronic device of claim 17, wherein the multi-pitch salience for each time interval of the plurality of time intervals of the target audio track includes a plurality of values, each value corresponding to a salience of a pitch during the time interval.

20. The electronic device of claim 18, wherein scoring the user's singing with respect to the target audio track by comparing, for each time interval of the plurality of time intervals of the target audio track, the pitch of the user's singing to the multi-pitch salience includes comparing a value, of the plurality of values, corresponding to the pitch of the user's singing to a maximum value of the plurality of values.

21. A non-transitory computer-readable storage medium storing one or more programs for execution by a first electronic device with one or more processors, the one or more programs comprising instructions for:
pre-processing a target audio track, including determining, for each time interval of a plurality of time intervals of the target audio track, a multi-pitch salience;
presenting the target audio track at a second electronic device associated with a user;
while presenting the target audio track at the second electronic device associated with the user, receiving an audio data stream representative of a user's musical performance; and
scoring the user's musical performance with respect to the target audio track by comparing, respectively, for each time interval of the plurality of time intervals of the target audio track, (i) a pitch of the user's musical performance represented by the audio data stream to (ii) the multi-pitch salience.
